(19) United States
(12) Patent Application Publication
(10) Pub. No.: US 2016/0308393 A1
(43) Pub. Date: Oct. 20, 2016

(54) CONTACTLESS POWER RECEIVER AND METHOD FOR OPERATING SAME

(71) Applicant: PowerbyProxi Limited, Freemans Bay, Auckland (NZ)

(72) Inventors: Arunim KUMAR, Freemans Bay, Auckland (NZ); Nigel GRAY, Freemans Bay, Auckland (NZ); Eugenio Jr. Sia LECIAS, Freemans Bay, Auckland (NZ); Junbo ZENG, Freemans Bay, Auckland (NZ); Ya-Ting WANG, Freemans Bay, Auckland (NZ)

(73) Assignee: PowerbyProxi Limited, Freemans Bay, Auckland (NZ)

(21) Appl. No.: 15/035,817

(22) PCT Filed: Nov. 7, 2014
(86) PCT No.: PCT/NZ2014/000229

§ 371 Date: May 11, 2016

(30) Foreign Application Priority Data
Nov. 11, 2013 (NZ) 617606

(51) Int. Cl. H02J 50/12; H02J 7/04; H02J 7/02

(52) U.S. Cl. CPC H02J 50/12; H02J 7/025; H02J 7/045; H02J 7/345

(57) ABSTRACT

A contactless power system comprising a power transmitter having a transmitting coil and a power receiver having a receiving coil, the power receiver being configured to receive power transmitted by the power transmitter via contactless electromagnetic coupling of the respective coils and deliver the received power to a load, wherein the receiving coil of the power receiver is part of a resonant circuit having a resonant frequency, the resonant circuit comprising a detuning element to detune the frequency of the resonant circuit from the resonant frequency in accordance with power requirements of the load.

### FIELD OF THE INVENTION

The present invention is in the technical field of contactless or inductively coupled power transfer (ICPT) systems. More particularly, although not exclusively, the present invention relates to a power receiver including dynamic load based tuning.

### BACKGROUND OF THE INVENTION

Contactless power systems typically consist of a power transmitter that generates an alternating magnetic field and one or more power receivers coupled to the generated magnetic field to provide a local power supply. These contactless power receivers are within proximity, but electrically isolated from, the power transmitter. A contactless power receiver includes a power receiving coil in which a voltage is induced by the magnetic field generated by the power transmitter, and supplies power to an electrical load.

One of the issues with contactless power receivers is their low efficiency when they are lightly loaded, for example when a rechargeable battery powered by a power receiver is nearly fully charged. This results in the need to regulate the power delivered to the receiver side load. Conventionally, control of the power delivered to the receiver side load is provided in a number of ways. For example, control can be applied at the transmitter side to achieve power flow control, or at the receiver side, or both.

In conventional receiver side control, the receiver coil is typically tuned to receive maximum power from the transmitter and then a power controller is used after rectification in order to deliver power to the receiver side load. One implementation of a power controller uses a shorting switch as part of the power receiving circuit to decouple the power receiving coil from the load as required. This approach is described in U.S. Pat. No. 5,293,308 and is referred to as “shorting control”. Although this approach addresses the above power flow control problem from the power receiving coil to the load, the shorting switch can cause large conduction losses, especially at light loads, because the power receiving coil is nearly always shorted under no load or light load conditions. This approach also requires a bulky and expensive DC inductor and generates significant electromagnetic interference.

Another problem with contactless power systems is frequency variations due to changes in load conditions and other circuit parameters. This can cause changes in the power receiving coil in terms of the induced voltage magnitude and short circuit current, which affect the power transfer capacity of the system. This is particularly a problem in fixed or passively tuned contactless power receivers.

One approach described in U.S. Pat. Nos. 8,093,758 and 7,382,636 is to dynamically tune the power receiving coil by varying the effective capacitance or inductance of the power receiver. This enables the contactless power receiver to compensate for frequency drifts caused by parameter changes. The effective capacitance or inductance is varied by employing two semiconductor switches in series with the capacitor or inductor. A means of sensing power receiving coil current magnitude and phase is required to enable soft switching of the variable capacitor or resistor. By implementing dynamic tuning not only can frequency drifts be compensated for but much higher quality factors (Q>10) can be realized than in passively tuned systems (normally Q<6) as the power receiving coil resonant frequency can be fine-tuned. A higher quality factor increases the power transfer capacity of the systems. However, this approach requires a power receiving coil sensor and complex control circuitry which does not support miniaturization of the contactless power pickup circuitry particularly at high frequencies. Further, this approach causes excessively high currents or voltages because either the inductor current can be switched off or the charged capacitor can be shorted during the switching process. The resulting switching transients contribute to EMI, unreliability of the switches, and reduces the system power efficiency due to excessive power losses. In the worst cases it can cause system failure.

### SUMMARY OF THE INVENTION

According to an exemplary embodiment of the present invention there is provided a contactless power system having a power transmitter having a transmitting coil and a power receiver having a receiving coil, the power receiver being configured to receive power transmitted by the power transmitter via contactless electromagnetic coupling of the respective coils and deliver the received power to a load, wherein the receiving coil of the power receiver is part of a resonant circuit having a resonant frequency, the resonant circuit having a detuning element to detune the frequency of the resonant circuit from the resonant frequency in accordance with power requirements of the load.

According to an exemplary embodiment the receiving coil is an inductance element and the resonant circuit of the power receiver has the inductance element in series with a capacitive element, the inductance and capacitance values of the inductance and capacitive elements being selected to provide the resonant frequency.

According to an exemplary embodiment the detuning element of the resonant circuit is configured as part of the capacitive element and as a variable capacitor. The variable capacitor may have a capacitor in series with a switch.

According to an exemplary embodiment the power receiver comprises controller configured to receive one or more signals in accordance with the power requirements of the load and to control operation of the switch in accordance with the received signals thereby varying the capacitance value of the variable capacitance and detuning the frequency of the resonant circuit from the resonant frequency.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention:

FIG. 1 illustrates a block diagram of an ICPT power receiver;

FIG. 2 illustrates an example of the power receiver of FIG. 1 employing tuning and detuning by way of a variable capacitance in series with a receiver coil;

FIG. 3 illustrates the relationship between the tuning capacitance and the output power of the power receiver of FIG. 2;

FIG. 4 illustrates another exemplary series tunedldetuned power receiver; and

FIG. 5 illustrates another exemplary series tuned/detuned power receiver.

### DETAILED DESCRIPTION OF EMBODIMENTS OF THE INVENTION

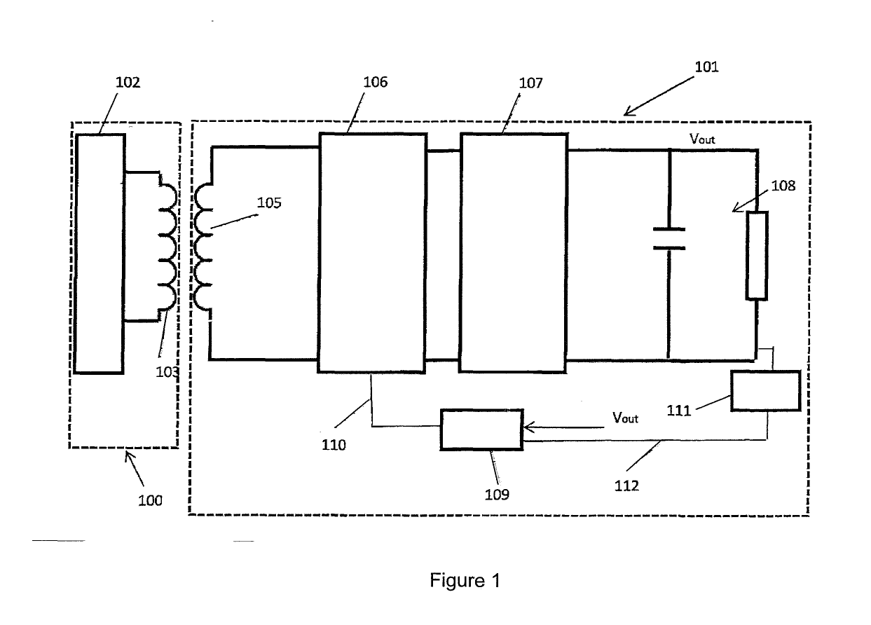

An exemplary contactless or inductively coupled power transfer (ICPT) system shown in FIG. 1 includes a power transmitter 100 and a power receiver 101. The transmitter 100 includes a controller 102 which drives a power transmitting coil 103 to generate a magnetic field. The transmitting coil 103 can be driven to generate an alternating magnetic field. The receiver 101 includes a power receiving coil 105, a tuning circuit 106, a rectifier 107, a load 108 and a tuning control circuit 109. The receiving coil 105 and tuning circuit 106 represent a resonant circuit. The transmitter 100 includes a similar resonant circuit with or without a tuning component.

When the receiving coil 105 is in close proximity to the transmitting coil 103, the magnetic field of the power transmitter 100 induces an electric current in the receiving coil 105. As the magnetic field is alternating, the induced alternating electric current is rectified by the rectifier 107 to be converted into a direct current which therefore delivers DC power to the load 108. To achieve this the rectifier 107 may be a half-bridge or full-bridge rectifier, and may further be a diode rectifier or a synchronous rectifier, however other implementations are possible. Further, implementations where AC power is to be delivered to the receiver side load are applicable to the present invention. The load 108 is depicted as a resistive load having a filtering capacitor for filtering the output voltage ripple.

The level of received power depends upon the frequency at which the resonant circuit of the receiver 101 is caused to resonate by the tuning circuit 106. Matching of the resonant frequencies of the transmitter and receiver resonant circuits allows maximum power transmission. However, the load 108, which for example may represent a chargeable battery of a consumer device, generally requires a consistent level of power to be provided until certain conditions are met, e.g., the consumer device battery is (near) fully charged. Therefore, the received power must be regulated so the power delivery requirements of the load 108 are met.

Unlike the conventional control methods discussed earlier, the present invention improves power flow control without increased complexity by tuning and detuning the resonant circuit of the receiver so that the receiver only receives sufficient power required by the load at any moment without including complex power regulator circuits or control sensors.

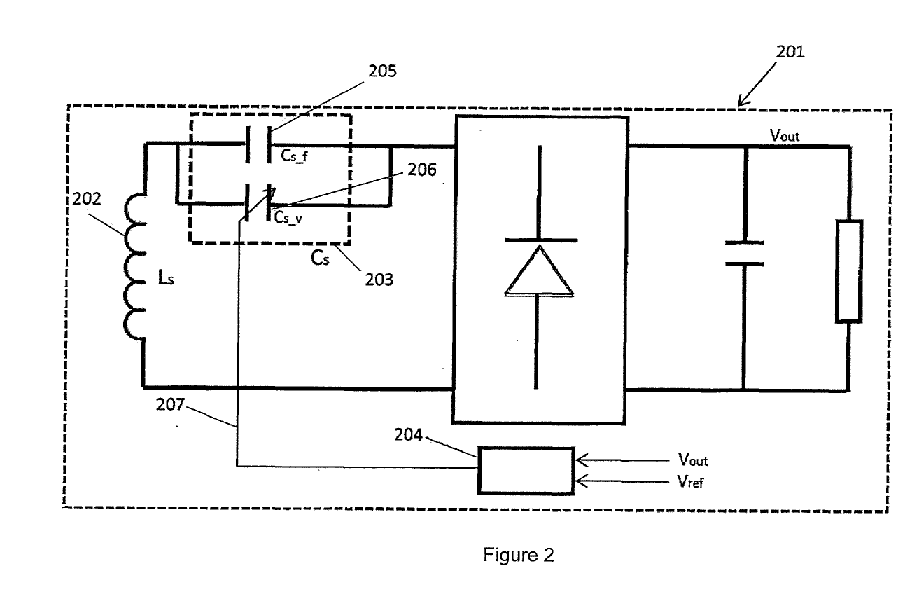

Control of the tuning/detuning in the system of FIG. 1 is provided by the control circuit 109 controlling the tuning circuit 106 via a control line 110. Tuning or detuning of the resonant circuit is performed in accordance with a reference signal provided by a sensor 111 to the control circuit 109 via a line 112. The sensor 111 senses the current at the load 108 and provides the reference signal to the control circuit 109. In FIG. 1, the sensor 111 is depicted as sensing the current at the low side of the load 108, however one of ordinary skill in the art understands that this is only exemplary, and sensing of the current at the high side of the load 108 is also possible. Accordingly, in FIGS. 2, 4 and 5, which illustrate alternative circuit level embodiments of the power receiver 101, depiction of the sensor 111 is omitted and the reference signal Vref is shown as an input to the control circuit 109. The manner of tuning control is now explained in detail with respect to FIGS. 2 to 5.

FIG. 2 illustrates an exemplary power receiver 201 having a power receiving coil 202 and a tuning circuit 203, together forming the receiver side resonant circuit, and a tuning control circuit 204. Other components of the receiver 201 are the same as illustrated for the receiver 101 of FIG. 1. The tuning circuit 203 includes a fixed capacitor 205 and a variable capacitor 206. The capacitors 205 and 206 are connected in series with the receiving coil 202, thereby forming a series resonant circuit, but are connected in parallel with one another. A tuning signal output from the control circuit 204 is provided to the variable capacitor 206 via a line 207.

The tuning capacitance Cs, provided by the sum of the fixed capacitance Cs_f of the capacitor 205 and the variable capacitance Cs_v of the capacitor 206, i.e., Cs=Cs_f +Cs_v, together with the inductance Ls of the receiver coil 202 provides the series resonant circuit. The value of the tuning capacitance Cs is controlled by the control circuit 204. As illustrated in FIG. 2, the control circuit 204 receives the rectified voltage Vout and the reference signal Vref (reference voltage) as inputs. The control circuit 204 is configured to compare the rectified voltage Vout to the reference voltage Vref and produce the tuning signal in accordance with this comparison. The tuning signal acts to change the variable capacitance Cs_v of the capacitor 206 thereby changing the tuning capacitance Cs.

This change in the tuning capacitance Cs changes the resonant frequency f of the resonant circuit in accordance with Equation 1:

$$f = \frac{1}{2 π \sqrt{Ls \times Cs}} \qquad Equation 1$$

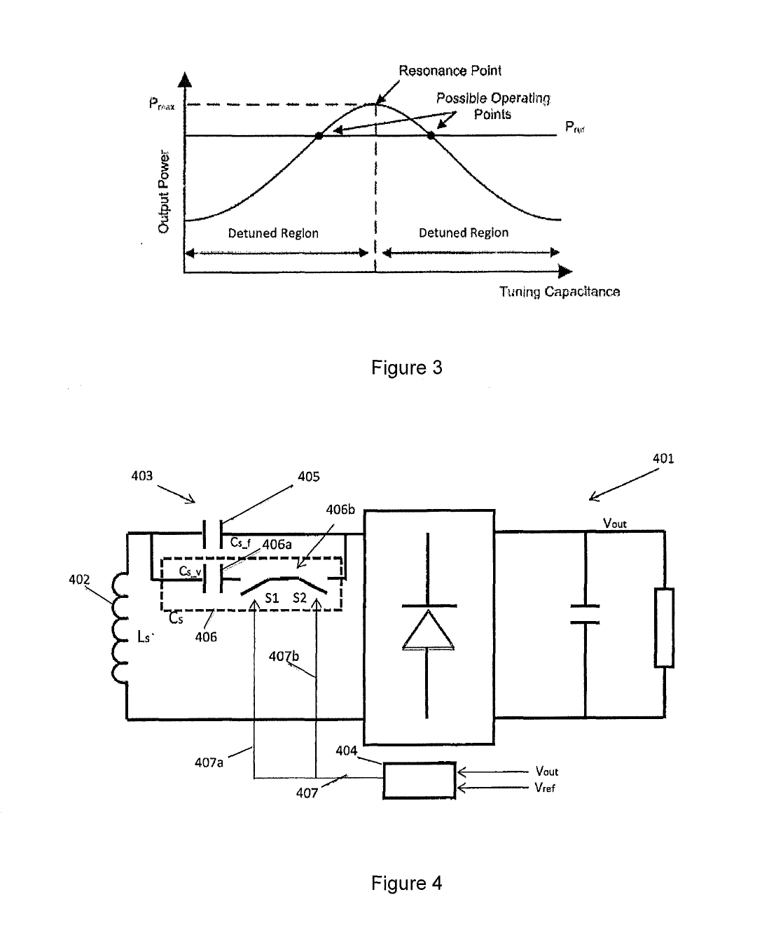

As can be seen from the above, because the resonant frequency f is varied in accordance with the relative voltage drop over the receiver side load the resonant circuit is tuned and detuned based on the power requirements of the receiver side load. This advantageous condition is illustrated in FIG. 3 where the Resonance Point is the point at which the variable capacitance Cs_v of the capacitor 206 is switched out of the tuning circuit 203 and the Detuned Regions are where some values of variable capacitance Cs_v of the capacitor 206 is added to the tuning capacitance Cs. In this way, the actual load conditions are sensed and used to tune and detune the resonant circuit in an efficient manner.

The variable capacitance of the tuning circuit can be provided in different ways. It is possible to use a mechanical variable capacitor. However, this is not ideal as mechanical variable capacitors need to be adjusted manually, such that if there is a change in the circuit parameters or the loading conditions, new manual adjustment is required. It is therefore preferable to implement an electronically controlled variable capacitance.

In one embodiment it is possible to provide an electronically controlled variable capacitance by using a number of fixed-value capacitors in parallel with one another and each having an associated switch in series, where operation of the switches is individually controlled based on the tuning signal from the tuning control circuit. However, whilst this embodiment involves a simple mechanism of providing a variable capacitance, a relatively large bank of parallel selectively switched capacitors would probably be needed in order to control the tuning of the receiver side resonant circuit over the entire range of required power conditions of the receiver load. If the power receiver is provided as part of a consumer device with the load representing a rechargeable battery the possible required power ranges maybe, for example, 0 W to 7.5 W for smartphones, 0 W to 10 W for tablets, and 0 W to 15 W for portable computers. Having said this, this simple mechanism of providing a range of variable capacitances that can be selectively switched into the tuning capacitance circuit could provide further advantages in cost effectively manufacturing the power receiver power flow control circuitry.

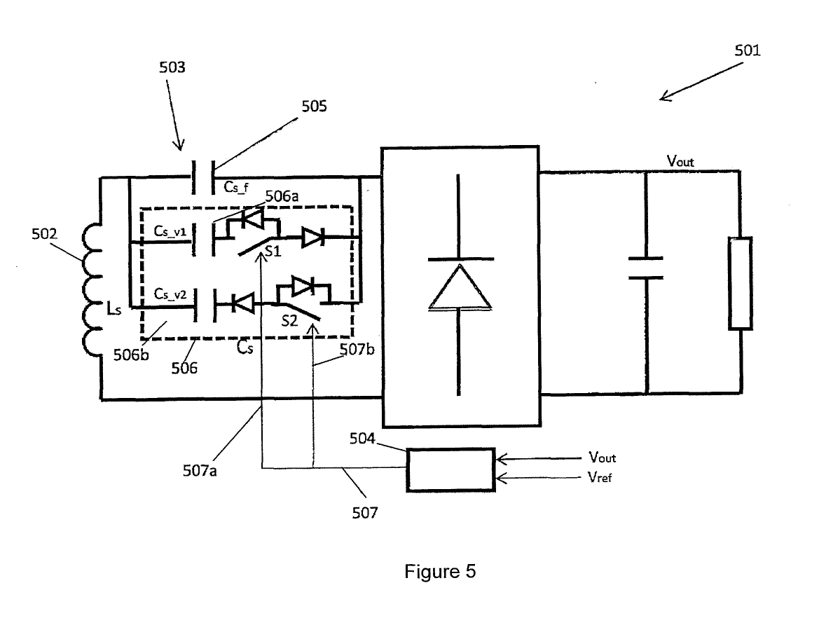

In an alternative embodiment, an electronically controlled variable capacitance is provided by controlling the average charging current of a single fixed-value capacitor thereby resulting in an equivalent variable capacitance. This is achieved by placing one or more semiconductor switches in series with the fixed-value capacitor and operating the switches based on the tuning signal of the tuning control circuit. This alternative embodiment provides tuning/detuning over a wide range of required power conditions of possible receiver load types whilst using a small number of components. FIGS. 4 and 5 illustrate specific exemplary configurations of the alternative embodiment.

FIG. 4 illustrates an exemplary power receiver 401 having a power receiving coil 402 and a tuning circuit 403, forming the receiver side resonant circuit, and a tuning control circuit 404. Other components of the receiver 401 are the same as illustrated for the receivers of FIGS. 1 and 2. The tuning circuit 403 includes a fixed capacitor 405 and a variable capacitance circuit 406. The variable capacitance circuit 406 includes a fixed capacitor 406a connected in series with first and second semiconductor switches S1 and S2. The semiconductor switches S1 and S2 are each unidirectional switches, such as n-type or p-type MOSFETs, connected so as to provide power flow in opposite directions and therefore forming a bidirectional AC switch 406b (see also FIG. 5 which illustrates the body diodes of the switches and additional diodes needed to block the current. These diodes combine to allow current to flow in one direction even if the switch is off thereby ensuring current can flow in the selected direction only when the switch is on; these diode elements are also applicable to the FIG. 4 embodiment). Like the example of FIG. 2, the fixed capacitor 405 and the variable capacitance circuit 406 are connected in series with the receiving coil 402 and the capacitors 405 and 406a are connected in parallel with one another.

Line 407 from the control circuit 404 includes lines 407a and 407b which communicate the tuning signal output from the control circuit 404 respectively to the switches S1 and S2 of the switch 406b thereby controlling the switched state of the switches S1 and S2. This provides full cycle control of the variable capacitance Cs_v of the tuning circuit 403 as follows: when both switches S1 and S2 are off, current is blocked from flowing in either direction through the capacitor 406a; and when both switches S1 and S2 are on, current is able to flow in both directions through the capacitor 406a. This embodiment of the tuning circuit requires a gate driver to control operation of both switches S1 and S2 in a manner known to one of ordinary skill in the art. Accordingly, controlling the amount of time the switches S1 and S2 are on and off controls the amount of charge stored in the capacitor 406a which sets the value of the variable capacitance Cs_v.

FIG. 5 illustrates an exemplary power receiver 501 having a power receiving coil 502 and a tuning circuit 503, forming the receiver side resonant circuit, and a tuning control circuit 504. Other components of the receiver 501 are the same as illustrated for the receivers of FIGS. 1 and 2. The tuning circuit 503 includes a fixed capacitor 505 and a variable capacitance circuit 506. The variable capacitance circuit 506 includes a first fixed capacitor 506a connected in series with a first semiconductor switch S1 and a second fixed capacitor 506b connected in series with a second semiconductor switch S2. The semiconductor switches S1 and S2 are each unidirectional switches, such as n-type or p-type MOSFETs, and like the example of FIG. 4, are series connected to the respective fixed capacitors 506a and 506b so as to provide power flow in opposite directions. Like the example of FIG. 2, the fixed capacitor 505 and the variable capacitance circuit 506 are connected in series with the receiving coil 502 and each of the capacitors 505, 506a and 506b are connected in parallel with one another.

Line 507 from the control circuit 504 includes lines 507a and 507b which communicate the tuning signal output from the control circuit 504 respectively to the switches S1 and S2 thereby controlling the switched state of the switches S1 and S2. This provides half cycle control of the variable capacitances Cs_v1 and Cs_v2 of the tuning circuit 503 as follows: when both switches S1 and S2 are off, current is blocked from flowing in either direction through both of the capacitors 506a and 506b; and when both switches S1 and S2 are on, current is able to flow in only the respective direction through the capacitors 506a and 506b, thereby controlling half the cycle. This embodiment of the tuning circuit requires a gate driver to control operation of both switches S1 and S2 in a manner known to one of ordinary skill in the art.

In the exemplary embodiments of the present invention described herein, the reference signal to the control circuit 109 is based on the current sensed at the load 108 by the current sensor 111. It is noted that the current sensor is provided within the power receiver circuit in accordance with the Qi low power specification Versions 1.0 and 1.1 of the Wireless Power Consortium (WPC) and therefore the present invention makes advantageous use of the inherently provided current sensor in the operation of the detuning circuit. However, one of ordinary skill in the art understands that other components and methods can be used to provide the control circuit 109 with information on the receiver load conditions, particularly in power receivers which do not include a current sensor.

Further, in each of the described exemplary embodiments, the detuning circuit is provided in the power receiver of the ICPT system. However, one of ordinary skill in the art understands that locating the detuning circuitry within the power transmitter instead, or in addition to, the power receiver is possible in order to allow the power transmitter to similar detune the transmitter side resonant circuit whilst still providing the operation and advantages of the ICPT system of the present invention.

Furthermore, in each of the described exemplary embodiments, the variable capacitance of the tuning circuit is provided by a combination of a fixed capacitor and a variable capacitance components, such as a series switched fixed capacitor. However, it is possible that the tuning circuit be implemented using only a variable capacitance component. One of ordinary skill in the art understands that the relative term “fixed” as used in this description encompasses typical variations experienced by electrical components.

While the present invention has been illustrated by the description of the embodiments thereof, and while the embodiments have been described in detail, it is not intended to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the general inventive concept.

1. A contactless power system comprising a power transmitter having a transmitting coil and a power receiver having a receiving coil, the power receiver being configured to receive power transmitted by the power transmitter via contactless electromagnetic coupling of the respective coils and deliver the received power to a load, wherein the receiving coil of the power receiver is part of a resonant circuit having a resonant frequency, the resonant circuit comprising a detuning element to detune the frequency of the resonant circuit from the resonant frequency in accordance with power requirements of the load.

2. A system as claimed in claim 1, wherein the receiving coil is an inductance element and the resonant circuit of the power receiver comprises the inductance element in series with a capacitive element, the inductance and capacitance values of the inductance and capacitive elements being selected to provide the resonant frequency.

3. A system as claimed in claim 2, wherein the detuning element of the resonant circuit is configured as part of the capacitive element.

4. A system as claimed in claim 3, wherein the detuning element is a variable capacitor.

5. A system as claimed in claim 4, wherein the variable capacitor comprises a capacitor in series with a switch.

6. A system as claimed in claim 5, wherein the power receiver comprises controller configured to receive one or more signals in accordance with the power requirements of the load and to control operation of the switch in accordance with the received signals thereby varying the capacitance value of the variable capacitance and detuning the frequency of the resonant circuit from the resonant frequency.
